(19) United States
(12) Patent Application Publication
(10) Pub. No.: US 2015/0146134 A1
(43) Pub. Date: May 28, 2015

(54) LIQUID CRYSTAL COMPOSITION AND DISPLAY DEVICE INCLUDING THE SAME

(71) Applicant: Electronics and Telecommunications Research Institute, Daejeon (KR)

(72) Inventors: Gi Heon KIM, Daejeon (KR); Won Jae LEE, Daejeon (KR); Chul Am KIM, Daejeon (KR); Hojun RYU, Seoul (KR)

(73) Assignee: Electronics and Telecommunications Research Institute, Daejeon (KR)

(21) Appl. No.: 14/278,002

(22) Filed: May 15, 2014

(30) Foreign Application Priority Data
Nov. 26, 2013 (KR) 10-2013-0144641

(51) Int. Cl. C09K 19/60; G02F 1/1335

(52) U.S. Cl. CPC C09K 19/60; C09K 19/603; G02F 1/1336
USPC 349/62; 252/299.1

(57) ABSTRACT

Provided are a liquid crystal display device and a liquid crystal display device including the same. The liquid crystal display device includes a first substrate, a second substrate facing and separated from the first substrate, a liquid crystal layer disposed between the first and second substrates, and a light source providing light to the liquid crystal layer. The liquid crystal layer includes cholesteric liquid crystal and a dichromic dye. The cholesteric liquid crystal includes nematic liquid crystal and an optically active material, and selectively reflects light having a certain wavelength, and the dichromic dye transmits light selectively reflected from the cholesteric liquid crystal. An amount of the dichromic dye is about 0.01 to about 10 wt % based on a total amount of the liquid crystal layer.

### CROSS-REFERENCE TO RELATED APPLICATIONS

This U.S. non-provisional patent application claims priority under 35 U.S.C. §119 of Korean Patent Application No. 10-2013-0144641, filed on Nov. 26, 2013, the entire contents of which are hereby incorporated by reference.

### BACKGROUND

The present disclosure herein relates to a liquid crystal composition and a display device including the same, and more particularly, to a cholesteric liquid crystal composition and a display device including the same.

Generally, a liquid crystal display device includes a displaying unit having two displaying substrates and a liquid crystal layer disposed therebetween. On each of the two substrates, an electrode is formed. The liquid crystal display device displays desired images by applying a voltage to the electrode and generating an electric field in the liquid crystal layer, and by controlling the transmittance of light penetrating the liquid crystal layer by controlling the intensity of the electric field.

Recently, liquid crystal display devices including a liquid crystal layer containing cholesteric liquid crystal, which do not require a polarization plate or a color filter are under developing. Particularly, an application of the cholesteric liquid crystal to an advertising board, an e-book, etc. by using selective reflection and bistable behaviors has been suggested.

### SUMMARY

The present disclosure provides a liquid crystal display device having good manufacturing efficiency and light weight.

The present disclosure also provides a liquid crystal composition applicable to the above liquid crystal display device.

The tasks to be solved by the inventive concept is not limited to the above-described tasks, however other tasks not mentioned will be precisely understood from the following description by a person skilled in the art.

Embodiments of the inventive concept provide liquid crystal display devices including a first substrate, a second substrate facing and separated from the first substrate, a liquid crystal layer between the first and second substrates, and a light source providing light to the liquid crystal layer. The liquid crystal layer includes cholesteric liquid crystal and a dichromic dye. The cholesteric liquid crystal includes nematic liquid crystal and an optically active material, and selectively reflects light having a certain wavelength, and the dichromic dye transmits light selectively reflected from the cholesteric liquid crystal. An amount of the dichromic dye is about 0.01 to about 10 wt % based on a total amount of the liquid crystal layer.

In some embodiments, the light source may be on state in a dark environment, the cholesteric liquid crystal of the liquid crystal layer may selectively reflect light having the certain wavelength among generated light from the light source, and the dichromic dye of the liquid crystal layer may transmit light having a wavelength selectively reflected by the cholesteric liquid crystal, absorb light having other wavelengths, and realize an image.

In other embodiments, the light source may be off state in a bright environment, the cholesteric liquid crystal of the liquid crystal layer may selectively reflect light having the certain wavelength among generated light from natural light, and the dichromic dye of the liquid crystal layer may transmit light having a wavelength selectively reflected by the cholesteric liquid crystal, absorb light having other wavelengths, and realize an image.

In other embodiments of the inventive concept, liquid crystal compositions are provided. The liquid crystal compositions include cholesteric liquid crystal including nematic liquid crystal and an optically active material, and selectively reflecting light having a certain wavelength, and a dichromic dye transmitting a wavelength selectively reflected by the cholesteric liquid crystal. An amount of the dichromic dye is about 0.01 to about 10 wt % based on a total amount of the liquid crystal layer.

In some embodiments, the wavelength selectively reflected by the cholesteric liquid crystal may be determined by the amount of the optically active material.

In other embodiments, the cholesteric liquid crystal may reflect one wavelength among a red color wavelength, a green color wavelength and a blue color wavelength.

In still other embodiments, the dichromic dye may include at least one selected from the group consisting of a yellow color material, a cyan color material and a magenta color material.

In even other embodiments, the liquid crystal composition may further include a polymer dispersed therein.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a flowchart for explaining a method of preparing a liquid crystal composition according to an embodiment of the inventive concept;

FIG. 2 is a cross-sectional view for explaining a display device according to an embodiment of the inventive concept; and

FIGS. 3A and 3B are cross-sectional views for explaining a driving method of the display device shown in FIG. 2.

### DETAILED DESCRIPTION OF THE EMBODIMENTS

The advantages, other objects and the features of the inventive concept, and methods for attaining them will be described in example embodiments below with reference to the accompanying drawings. The inventive concept may, however, be embodied in different forms and should not be construed as limited to the embodiments set forth herein. Rather, these embodiments are provided so that this description will be thorough and complete, and will fully convey the scope of the present inventive concept to those skilled in the art.

It will also be understood that when an element is referred to as being ‘on’ another element, it can be directly on the other element, or intervening elements may also be present. In the drawings, the thickness of elements may be exaggerated for effective explanation of technical contents.

Example embodiments are described herein with reference to cross-sectional views and/or plan views that are schematic illustrations of idealized example embodiments. In the drawings, the sizes and relative sizes of layers and regions may be exaggerated for effective explanation of technical contents. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, a region illustrated as a rectangle will, typically, have rounded or curved features. Thus, the regions illustrated in the figures are schematic in nature and their shapes are not intended to illustrate the actual shape of a region of a device and are not intended to limit the scope of the present inventive concept. It will be understood that, although the terms first, second, etc. may be used herein to describe various elements, these elements should not be limited by these terms. These terms are only used to distinguish one element from another element. Example embodiments embodied and described herein may include complementary example embodiments thereof.

The terminology used herein is for the purpose of describing particular example embodiments only and is not intended to limit the present inventive concept. As used herein, the singular forms are intended to include the plural forms as well, unless the context clearly indicates otherwise. It will be further understood that the terms “comprises” and/or “comprising,” when used in this specification, specify the presence of stated elements but do not preclude the presence or addition of one or more other elements.

Hereinafter, exemplary embodiments of the inventive concept will be described in detail with reference to the accompanying drawings.

A liquid crystal composition according to an embodiment of the inventive concept may include cholesteric liquid crystal and a dichromic dye. According to an aspect, the amount of the dichromic dye may be from about 0.01 wt % to about 10 wt % based on the total amount of the liquid crystal composition.

The cholesteric liquid crystal may include nematic liquid crystal and an optically active material.

The nematic liquid crystal may include at least one selected from the group consisting of biphenyl-based, phenyl cyclohexyl-based, terphenyl-based, tran-based, pyrimidine-based, and stilbene-based liquid crystal. These materials may be used alone or as a combination of two or more.

The optically active material may be represented by the following Formula 1.

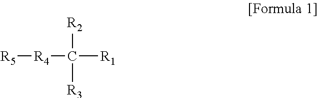

In Formula 1, R₁ may include H, CH₃ and C₂H₅, R₂ may be a group including C₆H₁₃ and OCO and having an aromatic group and/or an aliphatic group, and R₃ may include H, CH₃, C₂H₅ and Ar. R₁, R₂ and R₃ may form an asymmetric structure with C* as a center. R₄ may include O, CONH, COO, CN and OCO, R₅ may be X—B-A-, where A is a substitutable aromatic group or aliphatic group, B is a substitutable aromatic group or aliphatic group, and A and B may have different structures or may have a repeating structure. R₄ may be positioned between B and A of R₅. X may have an aliphatic compound structure of C₂ to C₇. In some cases, X may have a branch compound structure of C₂ to C₇.

The aromatic group of the optically active material is not specifically limited and may include a benzene ring such as a phenyl group; a condensed ring such as a naphthyl group, an anthryl group, and a phenanthryl group; the residual group of a heteroaromatic ring; and a combination thereof. The substituent is not specifically limited, but may include a methyl (CH₃) group, an ethyl (C₂H₅) group, an n-propyl (C₃H₇) group, F, Cl, Br, CF₃, CCl₃, etc.

According to the amount of the optically active material included in the cholesteric liquid crystal, the wavelength of reflected light may be selected. For example, as the amount of the optically active material in the cholesteric liquid crystal increases, the cholesteric liquid crystal may selectively reflect in order of a red color wavelength, a green color wavelength and a blue color wavelength.

The dichromic dye may transmit only light having the same wavelength as that of light selectively reflected by the cholesteric liquid crystal and may absorb light having other wavelengths. The dichromic dye may include at least one selected from the group consisting of a yellow color material, a magenta color material and a cyan color material. According to an aspect, the wavelength of the transmitting light of the dichromic dye may be selected according to the mixing amount of the yellow color material, the magenta color material and the cyan color material.

The yellow color material may have a connecting structure of two aromatic rings through an azo group. The yellow color material may be represented by the following Formula 2.

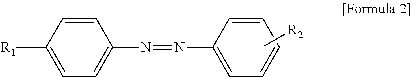

In Formula 2, R₁ and R₂ may be the same or different. R₂ may include one among —H, —CH₃, —C₂H₅, a linear alkyl group of at least C₃, a branch alkyl group of at least C₃, a linear alkene of at least C₃, a branch alkene of at least C₃, and at least one aromatic group. R₁ may include one among —HC(CH₃)₂, —N(CH₃)₂, and —N(alkyl chain of at least C₃)₂.

The magenta color material may be represented by the following Formula 3.

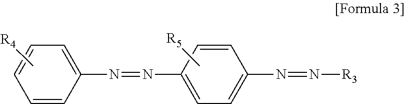

In Formula 3, R₄ and R₅ may be the same or different. R₄ may include one among —H, —CH₃, —C₂H₅, a linear alkyl group of at least C₃, a branch alkyl group of at least C₃, a linear alkene of at least C₃, a branch alkene of at least C₃, and at least one aromatic group. R₅ may include one among —H, —CH₃, —C₂H₅, a linear alkyl group of at least C₃, a branch alkyl group of at least C₃, a linear alkene of at least C₃, a branch alkene of at least C₃, and at least one aromatic group. R₄ may include one among the compounds illustrated in the following Formula 4.

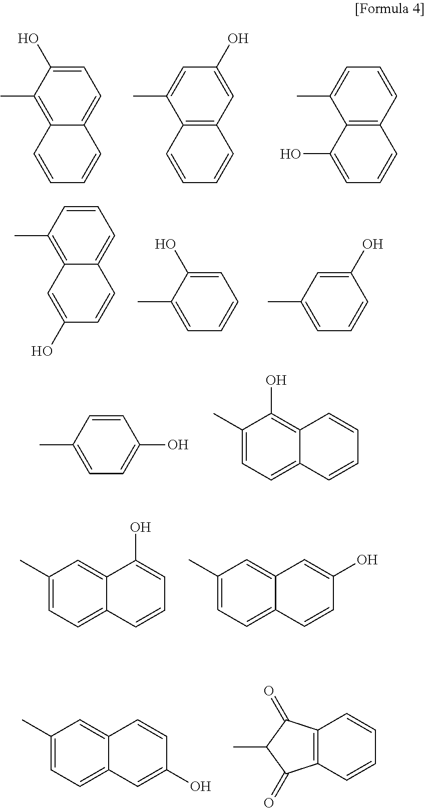

The cyan color material may be represented by the following Formula 5.

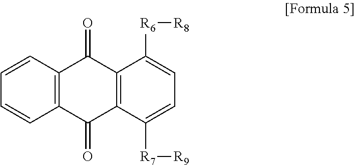

R₆ and R₇ may be the same or different. R₆ may include one among O, S, Se, CH₂, NH, and an ester group. R₇ may include one among O, S, Se, CH₂, NH, and an ester group.

R₈ and R₉ may be the same or different. R₈ may include one among —H, —CH₃, —C₂H₅, —C₃H₈, —C₄H₁₁, —C₅H₁₄, a linear alkyl group of at least C₆, a branch alkyl group of at least C₆, a linear alkene of at least C₃, a branch alkene of at least C₃, and at least one aromatic group. R₉ may include one among —H, —CH₃, —C₂H₅, —C₃H₈, —C₄H₁₁, —C₅H₁₄, a linear alkyl group of at least C₆, a branch alkyl group of at least C₆, a linear alkene of at least C₃, a branch alkene of at least C₃, and at least one aromatic group.

According to another embodiment of the inventive concept, the liquid crystal composition may further include a polymer dispersed in the liquid crystal composition. The liquid crystal composition may include a reactive transparent monomer and a photoinitiator.

The reactive transparent monomer may include an acryl-based, an aromatic-based, an acrylonitrile-based and a chloride-based monomer.

The acryl-based monomer may include triethylpropane triacrylate (TMPTA), tri(propylene glycol)diacrylate (TPGDA), pentaerythritol triacrylate (PETA), trimethylolopropane ethoxylate triacrylate (TMPEOTA), methyl methacrylate (MMA), methacrylate (MA), tri(propylene glycol)glycerolate diacrylate (TPGGDA), and vinylacrylate (VA), and the aromatic-based monomer may include styrene (ST) and divinyl benzene (DVB). The acrylonitrile-based (AN-based) monomer may include acrylonitile (AN). The chloride-based (Cl-based) monomer may include vinylidene chloride (VDC), vinylbenzyl chloride (VBC), vinyl stearate (VS), vinyl propionate (VP), vinyl acetate, vinyl pyrrolidone, and vinyl phenol. A mixed material of the above-described compounds may be used.

The photoinitiator may include at least one selected from the group consisting of 1-hydroxy-cyclohexyl-phenyl-ketone (Irgacure 907), 2-methyl-1[4-(methylthio)phenyl]-2-morpholinopropane-1-on (Irgacure 184C), 2-hydroxy-2-methyl-1-phenyl-propane-1-on (Darocur 1173), an initiator (Irgacure 500C) obtained by mixing about 50 wt % of Irgacure 184C and about 50 wt % of benzophenone, an initiator (Irgacure 1000) obtained by mixing about 20 wt % of Irgacure 184 and about 80 wt % of Irgacure 1173, 2-hydroxy-1-[4-(2-hydroxyethoxyl)phenyl]-2-methyl-1-propanone (Irgacure 2959), methylbenzoylformate (Darocur MBF), alpha, alpha-dimethoxy-alpha-phenylacetophenone (Irgacure 651), 2-benzyl-2-(dimethylamino)-1-[4-(4-morpholinyl)phenyl]-1-butanone (Irgacure 369), an initiator (Irgacure 1300) obtained by mixing about 30 wt % of Irgacure 369 and about 70 wt % of Irgacure 651, diphenyl(2,4,6-trimethylbenzoyl)-phosphine oxide (Darocur TPO), an initiator (Darocur 4265) obtained by mixing about 50 wt % of Darocur TPO and about 50 wt % of Darocur 1173, phosphine oxide, phenyl bis(2,4,6-trimethyl benzoyl (Irgacure 819), an initiator (Irgacure 2005) obtained by mixing about 5 wt % of Irgacure 819 and about 95 wt % of Darocur 1173, an initiator (Irgacure 2010) obtained by mixing about 10 wt % of Irgacure 819 and about 90 wt % of Darocur 1173, an initiator (Irgacure 2020) obtained by mixing about 20 wt % of Irgacure 819 and about 80 wt % of Darocur 1173, bis(.eta.5-2,4-cyclopentadiene-1-yl)bis[2,6-difluoro-3-[1H-pyrrol-1-yl]phenyl]titanium (Irgacure 784), and a mixture initiator (HSP 188) containing benzophenone.

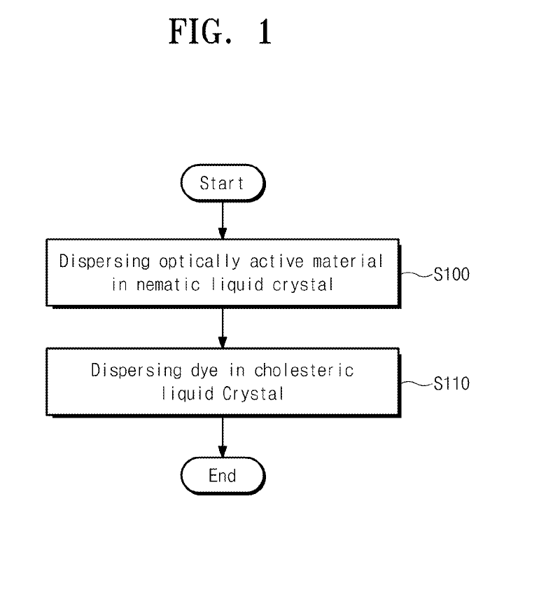

FIG. 1 is a flowchart for explaining a method of preparing a liquid crystal composition according to an embodiment of the inventive concept.

Referring to FIG. 1, an optically active material is dispersed in nematic liquid crystal to form cholesteric liquid crystal (Step S100).

According to an aspect, the wavelength of reflected light by the cholesteric liquid crystal may be determined according to the amount of the optically active material dispersed in the nematic liquid crystal. For example, when about 5 to about 30 wt % of the optically active material is included in the cholesteric liquid crystal, the cholesteric liquid crystal may selectively reflect the light of a red color wavelength. When about 6 wt % to about 35 wt % of the optically active material is included in the cholesteric liquid crystal, the cholesteric liquid crystal may selectively reflect the light of a green color wavelength. When about 8 wt % to about 40 wt % of the optically active material is included in the cholesteric liquid crystal, the cholesteric liquid crystal may selectively reflect the light of a blue color wavelength.

A dichromic dye may be dispersed in the cholesteric liquid crystal (Step S110). According to an embodiment of the inventive concept, the dichromic dye may have properties of transmitting light having a selectively reflected wavelength by the cholesteric liquid crystal. The dichromic dye may be included by about 0.01 to about 10 wt % based on the total amount of the liquid crystal composition.

According to an aspect, the dichromic dye may include at least one selected from the group consisting of a yellow color material, a magenta color material and a cyan color material. According to the mixing amount of the yellow color material, the magenta color material and the cyan color material, the wavelength of light passing through the dichromic dye may be determined. For example, when a dichromic dye obtained by mixing about 3.5 to about 4.5 wt % of the magenta color material and about 1 to about 2 wt % of the cyan color material is included by about 0.5 to about 3 wt % of the total amount of the liquid crystal composition, the liquid crystal composition thus obtained may transmit light having a red color wavelength. When a dichromic dye obtained by mixing about 0.5 to about 1.5 wt % of the yellow color material and about 2 to about 3.5 wt % of the cyan color material is included by about 0.5 to about 3 wt % of the total amount of the liquid crystal composition, the liquid crystal composition thus obtained may transmit light having a green color wavelength. When a dichromic dye obtained by mixing about 0.3 to about 1 wt % of the magenta color material and about 2 to about 3 wt % of the cyan color material is included by about 0.5 to about 3 wt % of the total amount of the liquid crystal composition, the liquid crystal composition thus obtained may transmit light having a blue color wavelength.

The examples of the nematic liquid crystal, the optically active material and the dichromic dye are substantially the same as those explained for the liquid crystal composition, and detailed explanation thereof will be omitted.

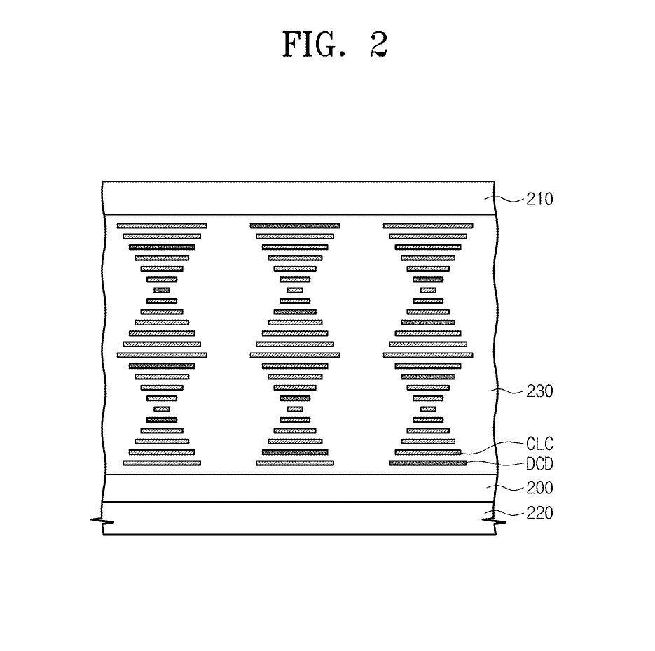

FIG. 2 is a cross-sectional view for explaining a display device according to an embodiment of the inventive concept.

Referring to FIG. 2, a display device may include a first substrate 200, a second substrate 210, a liquid crystal layer 230 and a light source 220.

The first substrate 200 may include a transparent material. For example, the first substrate 200 may include glass, quartz and/or a synthetic resin. The first substrate 200 may include a first electrode (not shown). The first electrode may include a transparent conductive material. For example, the first electrode may include one of indium tin oxide (ITO) and indium zinc oxide (IZO). According to an aspect, the first electrode may be provided as a pixel electrode, and the first electrode may be disposed in a unit pixel.

The second substrate 210 may face the first substrate 200 and may be disposed with a certain distance. The second substrate 210 may include a transparent material. For example, the second substrate 210 may include glass, quartz and/or a synthetic resin. The second substrate 210 may include a second electrode (not shown). The second electrode may include a transparent conductive material. For example, the second electrode may include one among ITO and IZO. According to an aspect, the second electrode may be provided as a common electrode.

The liquid crystal layer 230 may be disposed between the first and second substrates 200 and 210. The liquid crystal layer 230 may include a liquid crystal composition. The liquid crystal composition may include cholesteric liquid crystal (CLC) containing nematic liquid crystal and an optically active material, and a dichromic dye (DCD).

The CLC may have a helical structure having a certain period. The CLC may have selective reflecting properties of reflecting circularly polarized light having the same direction as a helically rotating direction and of transmitting circularly polarized light having a counter direction among incident light in parallel to the helical axis. The central wavelength (λ) and the wavelength band width (Δλ) of the reflecting light may be respectively represented by λ=n×p and Δλ=Δn×p (where, n is the mean refractive index of liquid crystal perpendicular to a helical axis, p is the pitch of a helix, and Δn is the refractive anisotropy of liquid crystal).

The state of the CLC may be changed to a planar state, a focal conic state and a homeotropic state according to the electric field between the first and second electrodes. The planar state of the CLC may be a state obtained when the helical axis of the CLC is perpendicular to a substrate, the focal conic state of the CLC may be a state when the helical axis is in parallel to the substrate, and the homeotropic state of the CLC may be a state when the helical structure of the CLC is collapsed and all of the liquid crystal are uniaxially aligned. In the planar state, selective reflection may be generated, in the focal conic state, diffused reflection may be generated, and in the homeotropic state, light may passing through. In the planar state and the focal conic state, bistable behaviors may be attained even though an electric field is not applied between the first and second substrates 200 and 210. Thus, a display device including the CLC may not require a polarization plate or a color filter.

The examples and detailed explanation on the constituent elements included in the liquid crystal composition are substantially the same as those explained above, and detailed explanation thereof will be omitted.

The light source 220 may be disposed in one side of the first substrate 200. The light source 200 may include a commonly used backlight unit.

Hereinafter a driving method of the liquid crystal display device will be explained.

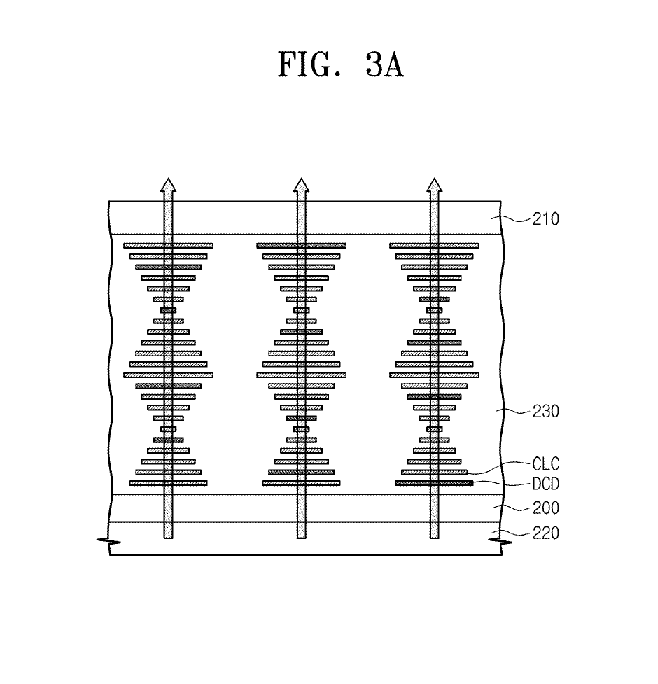

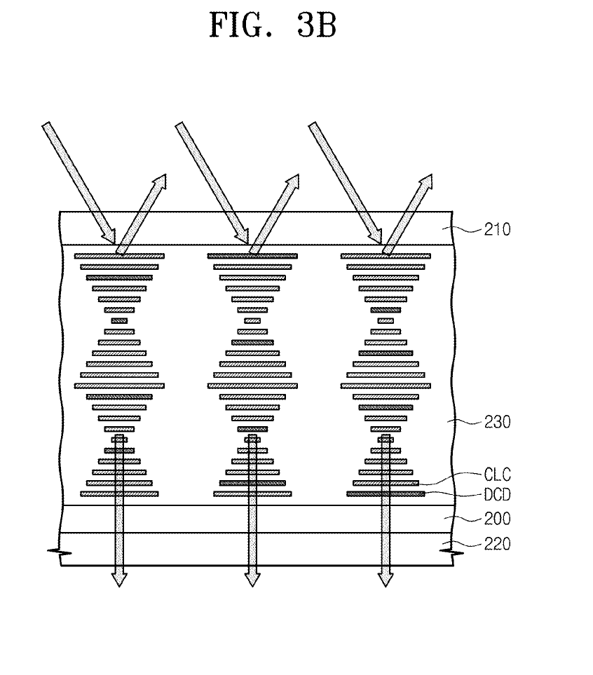

FIGS. 3A and 3B are cross-sectional views for explaining a driving method of the display device shown in FIG. 2

Referring to FIG. 3A, the driving of a liquid crystal display device when an external environment is dark will be explained. A light source 220 may be turned on to expose a liquid crystal layer 230 to light. The CLC of the liquid crystal layer 230 selectively reflects light having a coincident wavelength with the rotational direction of the helix thereof toward the direction of the light source 220 and transmits light having other wavelengths. The DCD of the liquid crystal layer 230 may transmit light having a wavelength reflected from the CLC and may absorb light having other wavelengths. Since the quantity of light transmitted and absorbed by the DCD is superior to the quantity of light selectively reflected and transmitted by the CLC, images may be realized by the wavelength of the transmitted light of the DCD.

Referring to FIG. 3B, the driving of a liquid crystal display device when an external environment is bright will be explained. A light source 220 may be turned off to expose a liquid crystal layer 230 to natural light. The CLC of the liquid crystal layer 230 selectively reflects light having a coincident wavelength with the rotational direction of the helix thereof toward the direction of the natural light and transmits light having other wavelengths. The DCD of the liquid crystal layer 230 may transmit light having a wavelength reflected from the CLC and may absorb light having other wavelengths, thereby realizing an image.

According to exemplary embodiments of the inventive concept, the manufacturing efficiency of a display device including cholesteric liquid crystal, in which a pixel has transmissive and reflective properties at the same time is good. In addition, the display device including the cholesteric liquid crystal may be light weight and thin because a color filter and a polarization plate are not necessary.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A liquid crystal display device, comprising:
a first substrate;
a second substrate facing and separated from the first substrate;
a liquid crystal layer between the first and second substrates; and
a light source providing light to the liquid crystal layer,
wherein the liquid crystal layer comprises cholesteric liquid crystal and a dichromic dye, the cholesteric liquid crystal including nematic liquid crystal and an optically active material, and selectively reflecting light having a certain wavelength, the dichromic dye transmitting light selectively reflected from the cholesteric liquid crystal,
wherein an amount of the dichromic dye is about 0.01 to about 10 wt % based on a total amount of the liquid crystal layer.

2. The liquid crystal display device of claim 1, wherein the light source is on state in a dark environment,
the cholesteric liquid crystal of the liquid crystal layer selectively reflects light having the certain wavelength among generated light from the light source, and
the dichromic dye of the liquid crystal layer transmits light having a wavelength selectively reflected by the cholesteric liquid crystal, absorbs light having other wavelengths, and realizes an image.

3. The liquid crystal display device of claim 1, wherein the light source is off state in a bright environment,
the cholesteric liquid crystal of the liquid crystal layer selectively reflects light having the certain wavelength among generated light from natural light, and
the dichromic dye of the liquid crystal layer transmits light having a wavelength selectively reflected by the cholesteric liquid crystal, absorbs light having other wavelengths, and realizes an image.

4. A liquid crystal composition, comprising:
cholesteric liquid crystal comprising nematic liquid crystal and an optically active material, the cholesteric liquid crystal selectively reflecting light having a certain wavelength; and
a dichromic dye transmitting a wavelength selectively reflected by the cholesteric liquid crystal,
wherein an amount of the dichromic dye is about 0.01 to about 10 wt % based on a total amount of the liquid crystal layer.

5. The liquid crystal composition of claim 4, wherein the wavelength selectively reflected by the cholesteric liquid crystal is determined by the amount of the optically active material.

6. The liquid crystal composition of claim 4, wherein the cholesteric liquid crystal reflects one wavelength among a red color wavelength, a green color wavelength and a blue color wavelength.

7. The liquid crystal composition of claim 4, wherein the dichromic dye comprises at least one selected from the group consisting of a yellow color material, a cyan color material and a magenta color material.

8. The liquid crystal composition of claim 4, further comprising a polymer dispersed therein.
